(19) United States
(12) Patent Application Publication
(10) Pub. No.: US 2015/0370112 A1
(43) Pub. Date: Dec. 24, 2015

(54) MULTI-DISPLAY APPARATUS

(71) Applicant: SHARP KABUSHIKI KAISHA, Osaka-shi, Osaka (JP)

(72) Inventor: Daiichi SAWABE, Osaka-shi (JP)

(73) Assignee: SHARP KABUSHIKI KAISHA, Osaka-shi, Osaka (JP)

(21) Appl. No.: 14/410,165

(22) PCT Filed: Jun. 3, 2013
(86) PCT No.: PCT/JP2013/065363

§ 371 Date: Dec. 22, 2014

(30) Foreign Application Priority Data
Jun. 27, 2012 (JP) 2012-144509

(51) Int. Cl. G02F 1/1333; G06F 3/14

(52) U.S. Cl. CPC G02F 1/13336; G06F 3/1423; G02F 1/133351

(57) ABSTRACT

A multi-display apparatus includes a plurality of liquid crystal display panels which are arranged to be tiled together contiguously for displaying an image respectively based on an input image signal, wherein at least two of the plurality of liquid crystal display panels are cut out and fabricated from one mother panel having a gap formed for sealing a liquid crystal material.

### CROSS-REFERENCE TO RELATED APPLICATIONS

This application is the national phase of PCT International Application No. PCT/JP2013/065363 which has an International filing date of Jun. 3, 2013 and designated the United States of America.

### FIELD

The present application relates to a multi-display apparatus configured to arrange a plurality of liquid crystal display panels for displaying an image.

### BACKGROUND

Liquid crystal display apparatuses are widely used in computer displays, television receivers, information displays for displaying various information, or the like.

Recently, a multi-display apparatus displaying a large screen by arranging a plurality of display panels to be tiled together contiguously and displaying an image part by part on each of the respective display panels (for example, see Japanese Patent Application Laid-Open Publication No. H5-173523). Liquid crystal display panels are used in a display panel configured with this multi-display apparatus.

With regard to a display apparatus in which a display image is viewed by a number of viewers such as an information display placed in public space, it is preferable to reduce ununiformity on each of the display panels in order to maintain an image quality. With regard to a multi-display apparatus with the use of a plurality of display panels, there have been problems such as a boundary existing between the display panels and image quality obviously being in discontinuity around the boundary of the display panels due to the occurrence of variation in each individual of display panels.

### SUMMARY

In view of such circumstances, the present application aims to provide a multi-display apparatus included a plurality of liquid crystal panels which can reduce ununiformity.

A multi-display apparatus according to the present application includes a plurality of liquid crystal display panels which are arranged to be tiled together contiguously for displaying an image respectively based on an input image signal, wherein at least two of the plurality of liquid crystal display panels are cut out and fabricated from one mother panel having a gap formed for sealing a liquid crystal material.

Cell thickness of a liquid crystal display panel is in several micrometers, and chromaticity and luminosity (luminance) are varied by difference in degree of one-hundredth of a micrometer. Since a gap for sealing the liquid crystal material is formed by bonding two glass substrates together while creating a panel member (mother panel), the variation in cell thickness between different panel members is larger than the variation in cell thickness of the same member panels. According to the present application, since at least two of the plurality of liquid crystal display panels are cut out from the same panel member and fabricated, the chromaticity and luminosity are uniform overall.

The multi-display apparatus according to the present application is characterized in that two contiguous liquid crystal display panels among the plurality of liquid crystal display panels are configured as the liquid crystal display panels fabricated from said one mother panel.

According to the present application, the difference in chromaticity and luminosity around the boundary of contiguous liquid crystal display panels becomes smaller, therefore, non-continuity in image quality between liquid crystal display panels is reduced.

The multi-display apparatus according to the present application is characterized in that at least two liquid crystal display panels are arranged to be tiled together contiguously so that arrangement relation of the liquid crystal display panels on said one mother panel is maintained.

According to the present application, liquid crystal display panels are arranged by maintaining the arrangement relation of the panels cut out from one mother panel, therefore, the non-continuity in chromaticity and luminosity between liquid crystal display panels can be suppressed.

The multi-display apparatus according to the present application is characterized in that information for specifying the mother panel from which the liquid crystal display panel is cut out is recorded in each of the liquid crystal display panels.

According to the present application, a liquid crystal display panel fabricated by cutting out from the same panel member can be identified by referring to information recorded in each of the liquid crystal display panels.

According to the present application, since at least two of a plurality of liquid crystal display panels configuring a multi-display apparatus are cut out and fabricated from the same panel member, the difference in chromaticity and luminosity around the boundary of liquid crystal display panels becomes small so that the non-continuity in image quality can be reduced.

The above and further objects and features of the invention will more fully be apparent from the following detailed description with accompanying drawings.

### BRIEF DESCRIPTION OF DRAWINGS

FIG. 1 is a schematic view showing a configuration example of a multi-display apparatus according to Embodiment 1;

FIG. 2 is a block diagram showing a configuration of a control system in the multi-display apparatus;

FIG. 3 is a schematic view showing a general configuration of a liquid crystal display panel to be used in the multi-display apparatus;

FIG. 4 is a schematic view illustrating a step for cutting a panel;

FIG. 5 is a schematic view showing the configuration of the liquid crystal display panel;

FIGS. 6A and 6B are a schematic view showing a configuration example of a multi-display apparatus according to Embodiment 2;

FIG. 7 is a schematic view showing a configuration example of a multi-display apparatus according to Embodiment 3;

FIG. 8 is a schematic view showing an example of a black matrix and a bezel existing in a surrounding of each liquid crystal display panel;

FIG. 9 is a schematic view illustrating a recording location of identification information;

FIG. 10 is a schematic view illustrating a location (address) of each panel cut from a mother panel;

FIG. 11 is a schematic view illustrating a technique for specifying a panel; and

FIG. 12 is a schematic view showing an example of assigning addresses due to size variation in the liquid crystal display panel.

### DESCRIPTION OF EMBODIMENTS

The present application is specifically illustrated with reference to the drawings showing the embodiments thereof.

### Embodiment 1

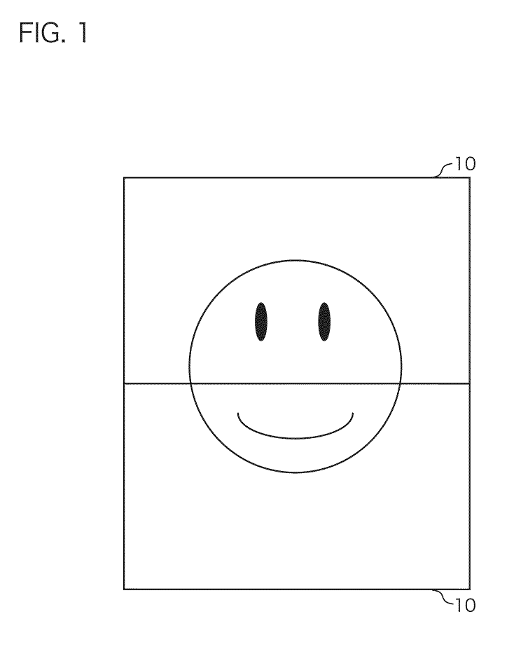

FIG. 1 is a schematic view showing a configuration example of a multi-display apparatus according to Embodiment 1. The multi-display apparatus according to Embodiment 1 is a display apparatus configured to arrange two liquid crystal display panels 10, 10. The configuration example shown in FIG. 1 shows that the rectangular liquid crystal display panels 10 are arranged vertically. The multi-display apparatus displays a large screen by dividing an image based on an input image signal (for example, a video signal) and then displaying the divided images in the two liquid crystal display panels 10, 10.

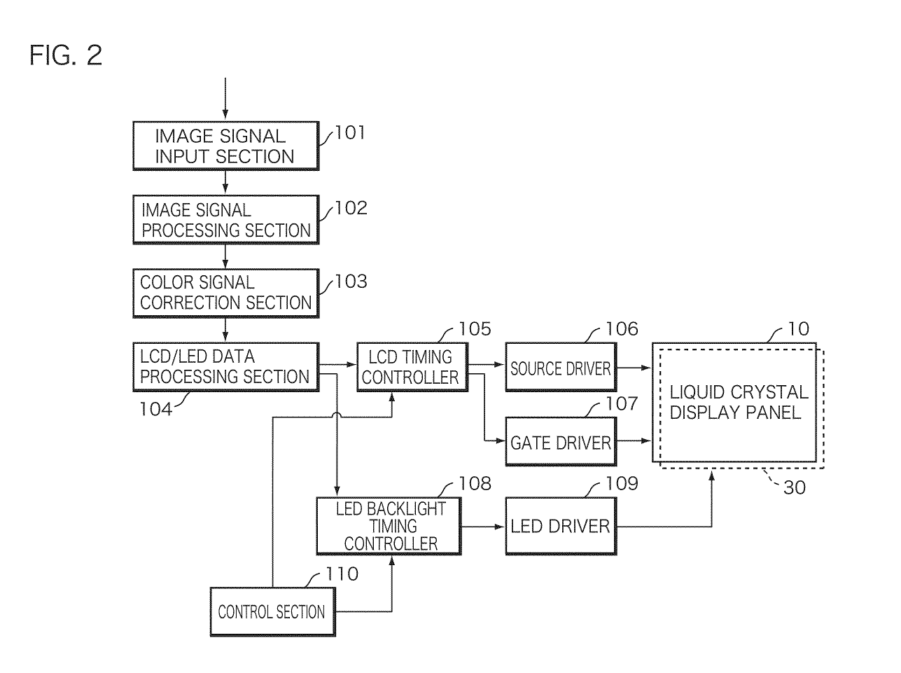

FIG. 2 is a block diagram showing a configuration of a control system in the multi-display apparatus. FIG. 2 shows the configuration of the control system in each of the liquid crystal display panels 10. Each of the liquid crystal display panels 10 is controlled by, for example, an image signal input section 101, an image signal processing section 102, a color signal correction section 103, an LCD/LED data processing section 104, an LCD timing controller 105, a source driver 106, a gate driver 107, an LED backlight timing controller 108, an LED driver 109 and a control section 110.

An image signal is inputted from outside through an image input terminal (not illustrated) such as an HDMI, a composite terminal and a D-Terminal. The multi-display apparatus generates an image signal for each of the liquid crystal display panels based on the image signal inputted from outside so that an image divided for matching the display screen size of each of the liquid crystal display panels 10 is displayed respectively in each of the liquid crystal display panels 10. A signal for each of the liquid crystal display panels generated by the multi-display apparatus is inputted to the image signal input section 101.

The image signal processing section 102 is a processing section for performing a variety of signal processes in response to the input image signal. The image signal processing section 102 executes, for example, processing for separating a horizontal synchronizing signal and a perpendicular synchronizing signal from the image signal, processing for generating a clock signal phase-locked to these synchronizing signals, and processing for separating a luminosity signal and a color signal from the image signal. In addition, the image signal processing section 102 may apply proper processing such as the superposition of on-screen displays (OSD) for a user interface.

The color signal correction section 103 applies image adjustment processing such as in saturation and sharpness for the image signal to be inputted through the image signal processing section 102.

Subsequent to the adjustment of a finally displayed image at the color signal correction section 103, the LCD/LED data processing section 104 separates the image signal into data for the liquid crystal display panel and backlight lighting data by an arithmetic operation. The LCD/LED data processing section 104 sends out the data for the liquid crystal display panel and backlight lighting data to the LCD timing controller 105 and the LED backlight timing controller 108, respectively.

The LCD timing controller 105 controls a driving of the source driver 106 and the gate driver 107 based on an LCD control signal provided from the control section 110 and data fed by the LCD/LED data processing section 104. In addition, the LED backlight timing controller 108 controls a driving of the LED driver 109 based on a backlight control signal provided from the control section 110 and data fed by the LCD/LED data processing section 104.

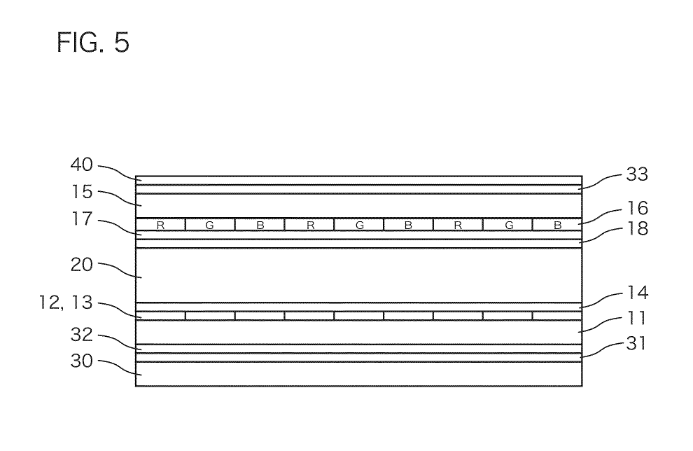

The multi-display apparatus as described above displays the image by controlling the driving of the source driver 106 and the gate driver 107 at each of the liquid crystal display panels 10, adjusting a magnitude of a voltage applied to a liquid crystal material, and controlling a light-on and a light-off timing of a backlight unit 30 (see FIG. 5), which will be described later.

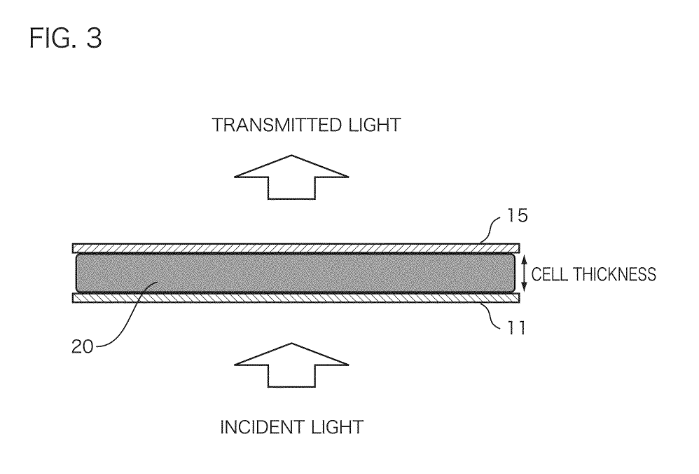

FIG. 3 is a schematic view showing the brief configuration of the liquid crystal display panel 10 to be used in the multi-display apparatus. The liquid crystal display panel 10 shown in FIG. 3 is a transmission type liquid crystal display panel. The following section describes the liquid crystal display panel 10 with reference to FIG. 5. The liquid crystal display panel 10 includes a glass substrate 11 (hereinafter also referred to as “a TFT side glass substrate 11”) where elements such as a TFT 12 (Thin Film Transistor) and a pixel electrode 13 are formed, and a glass substrate 15 (hereinafter also referred to as “a CF side glass substrate 15”), arranged to be opposite to the glass substrate 11, where a color filter 16 (CF: Color Filter), an counter electrode 17 and the like are formed. An air gap is formed between the two glass substrates 11, 15, and a liquid crystal layer 20 is formed by sealing the liquid crystal material into the gap. The liquid crystal display panel 10 displays the image by controlling a transmission rate of the liquid crystal material by applying a voltage between the pixel electrode 13 and the counter electrode 17 and adjusting the amount of light passing through between the two glass substrates 11, 15. In the transmission type liquid crystal display panel 10, light being incident from a back side of the TFT side glass substrate 11 with a use of the backlight unit 30.

With regard to the liquid crystal display panel 10, the optical property of the liquid crystal material between the glass substrates 11 and 15 is changed by varying a value of the voltage applied to the pixel electrode 13 and the counter electrode 17. However, in the case where a spacing (a cell thickness) between the two glass substrates 11, 15 is varied, the optical property of the liquid crystal material is also varied. For example, chromaticity is cyclically varied in the order of purple, blue, yellow, orange, red and purple as the cell thickness is varied from thin to thick. This is caused by double refraction in the liquid crystal material changing a spectrum of an incident light due to the thickness of the liquid crystal material. In a case where the cell thickness is 3 micrometers in liquid crystal material commonly used, for example, the chromaticity is shifted to the blue side, but is changed to the yellow side as the cell thickness becomes slightly thicker (about hundredth of one micrometer). In addition, since a value in luminosity converted from the blue spectrum to the yellow spectrum becomes larger, the luminosity goes up.

The cell thickness is varied resulting from variation in the fabrication process of the liquid crystal display panel 10. With regard to the display apparatus configured by only one liquid crystal display panel 10, since the chromaticity and the luminosity are continuously varied in a whole display screen, there is no big problem in a quality of the displayed image. However, with regard to the multi-display apparatus configured to arrange the plurality of the liquid crystal display panels 10, 10, in a case of using panels different in cell thickness, the chromaticity and the luminosity are different between the display panels and the continuity in an image at the boundary of the display screens (that is, a boundary between the two contiguous panels) is lost.

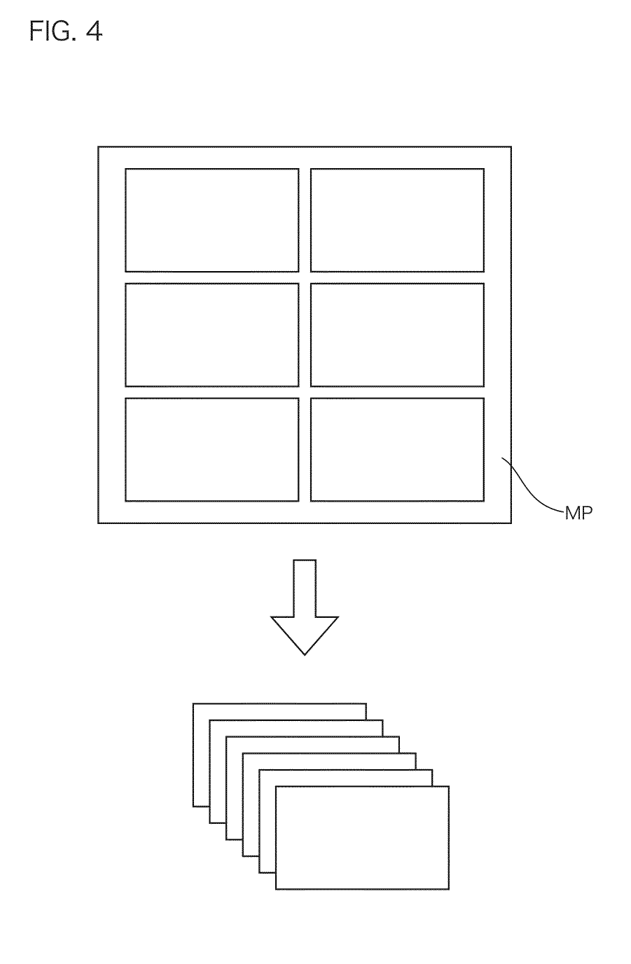

In order to solve such a problem, with regard to the present embodiment, two liquid crystal display panels 10, 10 for configuring the multi-display apparatus are cut out from one mother panel MP and fabricated (see FIG. 4). The variation in cell thickness within one mother panel is smaller than the variation in a plurality of mother panels MP, MP, . . . . Thus, by configuring the multi-display apparatus with the use of panels cut out from one mother panel MP, the variation in chromaticity and luminosity can be small at the boundary of display screens and better continuity in an image can be maintained.

FIG. 4 is a schematic view illustrating a step for cutting a panel. The mother panel MP is a panel member obtained by sticking the TFT side glass substrate 11 and the CF side glass substrate 15 together through a seal member, a gap for sealing the liquid crystal material being formed between the TFT side glass substrate 11 and the CF side glass substrate 15. The liquid crystal material is sealed in the fabrication step of the mother panel MP (before cutting the panel) or after cutting out each panel from the mother panel MP.

It is noted that the mother panel MP can be manufactured by using a well-known method, for example, using the method disclosed in Japanese Patent Application Laid-Open Publication No. 2011-145406.

FIG. 4 illustrates an example in that six panels are cut out from one mother panel MP. A well-known method such as a scribe and break method, a method disclosed in the above-mentioned publication or the like can be used for cutting the mother panel MP. Since the variation in cell thickness is relatively smaller within one mother panel MP, two liquid crystal display panels 10, 10 for configuring the multi-display apparatus can be fabricated, for example, by using two panels selected from any of six panels that have been cut out.

FIG. 5 is a schematic view showing the configuration of the liquid crystal display panel 10. The panels cut out from the mother panel MP configures an LCD module including the TFT side glass substrate 11, a liquid crystal layer 20 formed by sealing liquid crystal material and the CF side glass substrate 15. The pixel electrodes 13 for forming pixels, the TFTs 12 to be connected to the pixel electrodes 13 and an alignment layer 14 are formed on one surface of the TFT side glass substrate 11. In addition, color filters 16, the counter electrode 17 and an alignment film 18 are formed on one surface of the CF side glass substrate 15.

On the back side of this LCD module (the other side of the TFT side glass substrate 11), the backlight unit 30, a diffuser 31 and a polarizer 32 are provided. In addition, on the surface side of the LCD module (the other side of the CF side glass substrate 15), a polarizer 33 and a cover glass 40 are provided.

The backlight unit 30 is configured by, for example, an edge light type backlight having a light source for emitting light to a light guiding plate from the side and a light guiding plate for emitting incident light from the side to the LCD module side, or a direct LED backlight having a plurality of LEDs arranged to be opposite to the TFT side glass substrate.

The polarizer 32 is arranged at the surface of the TFT side glass substrate 11, and the polarizer 33 is arranged at the surface of the CF side glass substrate 15. The polarizers 32, 33 are provided to transmit linear polarized light beams orthogonal with each other.

The diffuser 31 is arranged between the polarizer 32 and the backlight unit 30, and has a function of causing light emitted from the backlight unit 30 to diffuse in all directions.

The cover glass 40 is arranged at a surface on a side opposite to the side facing the CF side glass substrate 15 of the polarizer 33, and has a function to protect the LCD module.

With this configuration, a linear polarized light beam passed through the polarizer 32 among light beams emitted from the backlight unit 30 passes through the liquid crystal layer 20 and enters the polarizer 33. At this time, the polarization state of light passing through the liquid crystal layer 20 can be varied by a voltage applied to the liquid crystal layer 20. Thus, by applying a voltage corresponding to the image signal to the pixel electrode 13 and the counter electrode 17 and applying an electrical field to the liquid crystal layer 20, the polarization state of light passing through the liquid crystal layer 20 is varied and the amount of light passing through the polarizer 32 is controlled so that an optical image can be formed.

In the present embodiment, the variation in chromaticity and luminosity of the panel associated with unevenness of cell thickness is described. However, the variation in chromaticity and luminosity of the panel is not only caused by unevenness of cell thickness. For example, the variation may occur in chromaticity and luminosity of the panel with unevenness of the film thickness of the alignment layers 14, 18 formed on the glass substrates 11, 15 respectively. As mentioned above, even when the variation in image quality arising from the fabrication process of the mother panel MP such as unevenness of cell thickness and unevenness of the film thicknesses of the alignment layers 14, 18, the difference in display quality between panels can be slightly suppressed since the multi-display apparatus is configured by using a plurality of panels cut out from one mother panel MP after fabricating the mother panel MP in this embodiment.

With regard to FIG. 5, the transmission type liquid crystal display panel 10 is illustrated. However, the multi-display apparatus may be configured by using a reflection type liquid crystal display panel.

### Embodiment 2

In Embodiment 1, the multi-display apparatus is configured by using two panels cut out from one mother panel MP. However, the number of panels for configuring the multi-display apparatus is not restricted to two. Note that, since there is a limit in the number of panels that can be cut out from one mother panel MP, in a case of configuring the multi-display apparatus by using more than two panels, it may not always be possible that all of the panels can be produced from the same mother panel MP.

The present embodiment illustrates the configuration of producing at least two panels from the same mother panel MP among the plurality of liquid crystal display panels 10, 10, 10, . . . for configuring the multi-display apparatus.

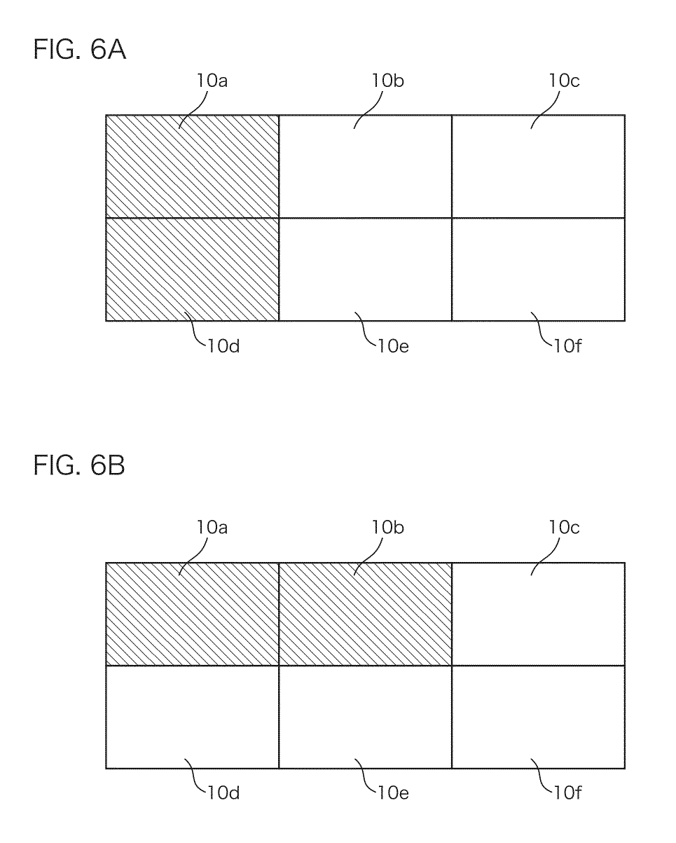

FIGS. 6A and 6B are a schematic view showing a configuration example of a multi-display apparatus according to Embodiment 2. The multi-display apparatus shown in FIGS. 6A and 6B includes six liquid crystal display panels 10a to 10f. Three liquid crystal display panels 10a, 10b, 10c are arranged at the upper portion horizontally, and three liquid crystal display panels 10d, 10e, 10f are arranged at the lower portion horizontally. The multi-display apparatus displays a large screen by dividing one image based on the input image signal into six liquid crystal display panels 10a to 10f and then displaying the image.

The configuration of each of the liquid crystal display panels 10a to 10f is exactly the same as the liquid crystal display panel 10 described in Embodiment 1. In addition, the configuration of the control system of the multi-display apparatus is also exactly the same as the one in Embodiment 1, therefore, the description thereof is not repeated.

The example shown in FIG. 6A illustrates that the two leftmost liquid crystal display panels 10a, 10d viewed from the front face of the panel among six liquid crystal display panels 10a to 10f are fabricated by using the panels cut out from one mother panel MP. The other four liquid crystal display panels 10b, 10c, 10e and 10f are fabricated by using panels cut out from another mother panel MP.

The example shown in FIG. 6B illustrates that the liquid crystal display panels 10a, 10b at the left and center in the upper portion viewed from the front panel are fabricated by using panels cut out from one mother panel MP. The other four liquid crystal display panels 10c to 10f are fabricated by using panels cut out from another mother panel MP.

As described above, with regard to Embodiment 2, since at least two panels among the plurality of liquid crystal display panels 10a to 10f configuring the multi-display apparatus are cut out from the same mother panel MP, the unity in image quality can be achieved as compared with the multi-display apparatus by using panels cut out from different mother panels MP, MP . . . .

### Embodiment 3

Embodiment 1 is configured by using the liquid crystal display panels 10, 10 by selecting and fabricating any two panels among a plurality of panels cut out from one mother panel MP in the multi-display apparatus. However, it is preferable that an arrangement relation of the cut-out panels on the mother panel MP is the same as the arrangement relation of the liquid crystal display panels 10 used in the multi-display apparatus.

The configuration of arranging each of the liquid crystal display panels 10, 10 . . . in view of the arrangement relation of panels cut out from the mother panel MP is described in Embodiment 3.

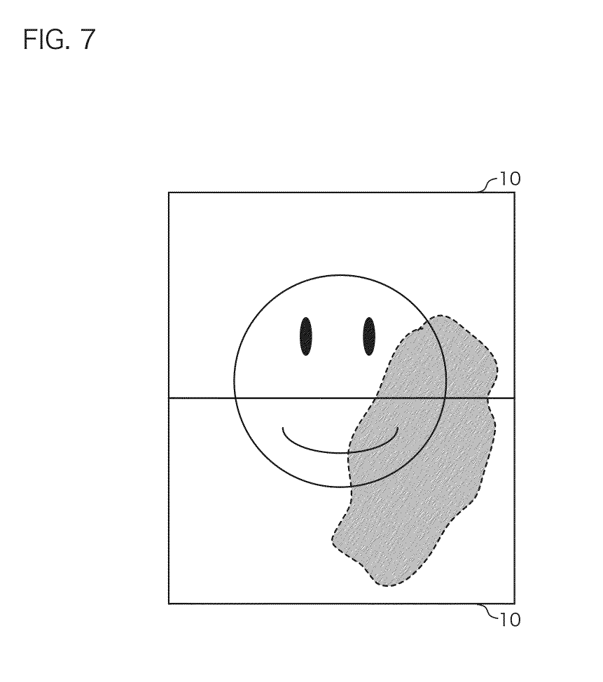

FIG. 7 is a schematic view showing a configuration example of a multi-display apparatus according to Embodiment 3. The multi-display apparatus according to Embodiment 3 is a display apparatus configured to arrange two liquid crystal display panels 10, 10 vertically. The multi-display apparatus displays a large screen by dividing one image based on the input image signal into the two liquid crystal display panels 10, 10 and displaying the image.

The configuration of the control system of the multi-display apparatus and the configuration of the liquid crystal display panel 10 are exactly the same as the ones in Embodiment 1, therefore, the description thereof is not repeated.

As described above, the optical properties (chromaticity and luminosity) of the liquid crystal display panel 10 are varied by the difference in the spacing (cell thickness) between the two glass substrates 11, 15. In a case where the variation in the cell thickness occurs in a local region, the chromaticity and the luminosity in this region are deviated from the chromaticity and luminosity in another area, a luminance irregularities or color irregularities are formed on a display screen. Since such the luminance irregularities or color irregularities are generated due to cell thickness and the variation in the display screen is moderate, there is no big problem when an image is displayed in one liquid crystal display panel 10. However, with regard to the multi-display apparatus configured by arranging a plurality of liquid crystal display panels 10, 10 . . . , in a case where the liquid crystal display panel 10 with luminance irregularities or color irregularities and the liquid crystal display panel 10 without luminance irregularities or color irregularities are arranged to be contiguous with each other, the continuity in a display image is lost since the chromaticity and the luminosity are suddenly changed near the boundary between these panels.

In order to solve this problem, with regard to Embodiment 3, two liquid crystal display panels 10, 10 configuring the multi-display apparatus are cut out from one mother panel MP and fabricated, and the liquid crystal display panels 10, 10 are arranged so that the arrangement relation of the cut-out panels on the mother panel MP is the same as the arrangement relation of the liquid crystal display panels on the multi-display apparatus.

As mentioned above, with regard to Embodiment 3, since each of the liquid crystal display panels 10, 10 is arranged and then the multi-display apparatus is manufactured such that the arrangement relation of the cut-out panels on the mother panel MP is the same as the arrangement relation of the liquid crystal display panels 10, 10 on the multi-display apparatus, the continuity in image quality can be maintained by arranging these panels to be contiguous to each other even when variation in image quality (luminance irregularities or color irregularities) occurs in the region contiguous with two liquid crystal display panels 10, 10.

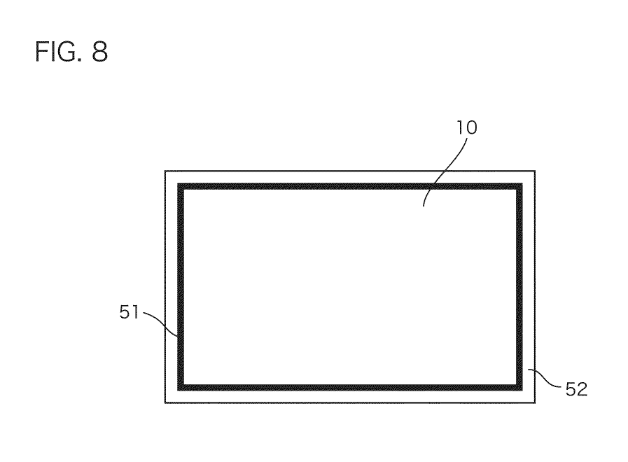

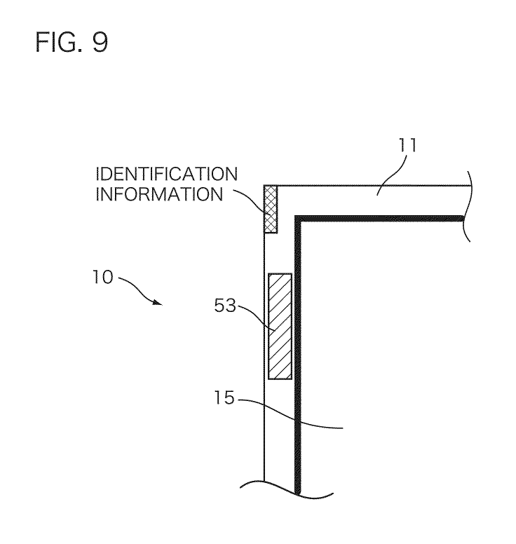

A black matrix and a bezel are provided at the surrounding of each of the liquid crystal display panels 10 for configuring the multi-display apparatus. FIG. 8 is a schematic view showing one example of the black matrix and the bezel existing at the surrounding of each of the liquid crystal display panels 10. As shown in FIG. 8, since a black matrix 51 and a bezel 52 exist at the surrounding of each of the liquid crystal display panels 10, even for the display with a narrow frame, the spacing of about 5 to 7 millimeters exists between the contiguous liquid crystal display panels 10, 10 of the multi-display apparatus. In addition, as shown in FIG. 4, while cutting out each of the panels from the mother panel MP, even for the contiguous panels, a proper spacing is provided for cutting out the panels. The arrangement for each of the panels on the mother panel MP is determined so that the number of panels cut out from the mother panel MP can be maximized. The spacing between panels cut out from the mother panel MP is determined by a variety of factors such as the size of the panel required (resolution), the number of drivers for driving the liquid crystal display panel 10 and the number of outputs of the whole drivers, whether or not a substrate for driving drivers is arranged at the liquid crystal display panel 10, the size of a connection terminal 53 (see FIG. 9) to be provided for each of the liquid crystal display panels 10, whether or not dummy pixels are provided, and a region for shielding light by the black matrix 51.

Therefore, even if the arrangement relation of the cut-out panels on the mother panel MP and the arrangement relation of each of the liquid crystal display panels 10, 10, . . . on the multi-display apparatus are arranged to be the same, the continuity in a display image cannot be strictly maintained near the boundary between the liquid crystal display panels 10, 10 which are configured the multi-display apparatus.

However, as compared with the case in which the liquid crystal display panel 10 with luminance irregularities or color irregularities and the liquid crystal display panel 10 without luminance irregularities or color irregularities are arranged to be contiguous with each other, non-continuity in image quality is obviously reduced so that a better display screen that is easy for a user to see can be provided.

### Embodiment 4

With regard to Embodiments 1 to 3, the liquid crystal display panels 10, 10, . . . for configuring the multi-display apparatus with the use of a plurality of panels cut out from one mother panel MP are fabricated. In particular, with regard to Embodiment 3, the multi-display apparatus with arrangement of the liquid crystal display panels 10, 10 are configured so that the arrangement relation of the cut-out panels on the mother panel and the arrangement relation of each of the liquid crystal display panels 10, 10 on the multi-display apparatus are the same. Thus, for the respective panels cut out from the mother panel MP, it is preferable to recognize each of the panels from information such as a panel cut out from which mother panel MP, a panel cut out from which position of the mother panel MP or the like.

With regard to Embodiment 4, the configuration for recording identification information for identifying each of the liquid crystal display panels 10 in each of the liquid crystal display panels 10 is described.

FIG. 9 is a schematic view illustrating a recording location for identification information. The dimension of the TFT side glass substrate 11 and the dimension of the CF side glass substrate 15 are different from each other. For example, the TFT side glass substrate 11 is relatively larger than the CF side glass substrate 15. That is, the region where the image is not displayed exists at the periphery of the TFT side glass substrate 11. It is possible to record the identification information for identifying each of the liquid crystal display panel 10 by using a method such as a laser marking at the periphery. The example shown in FIG. 9 illustrates the state where a connection terminal 53 for connecting a circuit for driving the liquid crystal display panel 10 or the like is provided at the periphery of the TFT side glass substrate 11, and where the identification information is recorded at the vicinity of the connection terminal 53 (the upper-left corner of the periphery).

The identification information may be confirmed by a human's eyes. Alternatively, the identification information with a size which cannot be visually recognized by a human eye may be engraved, and the identification information can be confirmed by means of a microscope or the like.

It is preferable that the identification information recorded in each of the liquid crystal display panels 10 is information that can identify a mother panel MP from which the panel is cut out. It is more preferable that the identification information is information that can specify which position of the mother panel MP is cut out. A sign configured in, for example, the year of production, the month of production (January to September denoted as 1 to 9 respectively, and October to December denoted as X, Y and Z, respectively), the date of production and a serial number (for example, a 5-digit number) indicative of the number of panels produced in each day, can be used as the identification information. In a case of adopting this identification information, for example, the liquid crystal display panel 10 having “12060100325” as the identification information corresponds to the 325^{th} panel produced in Jun. 1, 2012, and the liquid crystal display panel 10 having “11Z1000031” as the identification information corresponds to the 31^{st} panel produced in Dec. 10, 2011.

In a case of using the above-mentioned identification information as a form of cutting out six panels from one mother panel MP, the six panels provided with the last five-digit numbers in identification information as 6N, 6N+1, . . . , 6N+5 (N is an integer larger than or equal to 0) indicate that panels are cut out from the same mother panel MP. Accordingly, by referring to the identification information, the liquid display panels 10 fabricated by cutting out from one mother panel MP can be distinguished from the liquid crystal display panels 10 fabricated by cutting out from another mother panel MP.

By assigning the identification information in association with a position (address) of each of the panels cut out from the mother panel MP as a serial number, it is possible to specify which position of the mother panel MP is cut out for each of the panels based on the identification information.

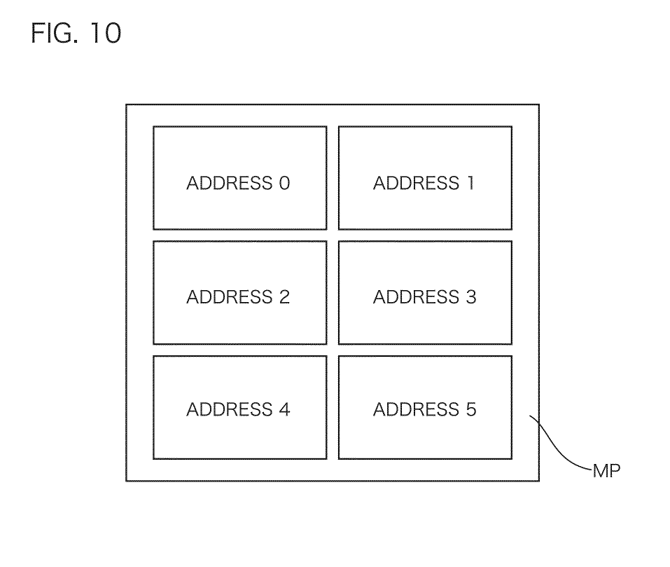

FIG. 10 is a schematic view illustrating a position (address) of each panel cut out from the mother panel MP. It is assumed that six panels are cut out from the mother panel MP, and the addresses according to the serial numbers are assigned as shown in FIG. 10. In a case of fabricating the liquid crystal display panel 10 by using the panel cut out from the position corresponding to “address 0,” the identification information in which the last-5 digits are configured as 6N is recorded in this liquid crystal display panel 10. It is also similar to fabricating the liquid crystal display panel 10 by using the panels cut out from positions corresponding to other addresses. The identification information in which the last 5-digit numbers are configured as 6N+1 to 6N+5 is recorded in each of the liquid crystal display panels 10 fabricated by using the panels cutting out from positions corresponding to “address 1” to “address 5.”

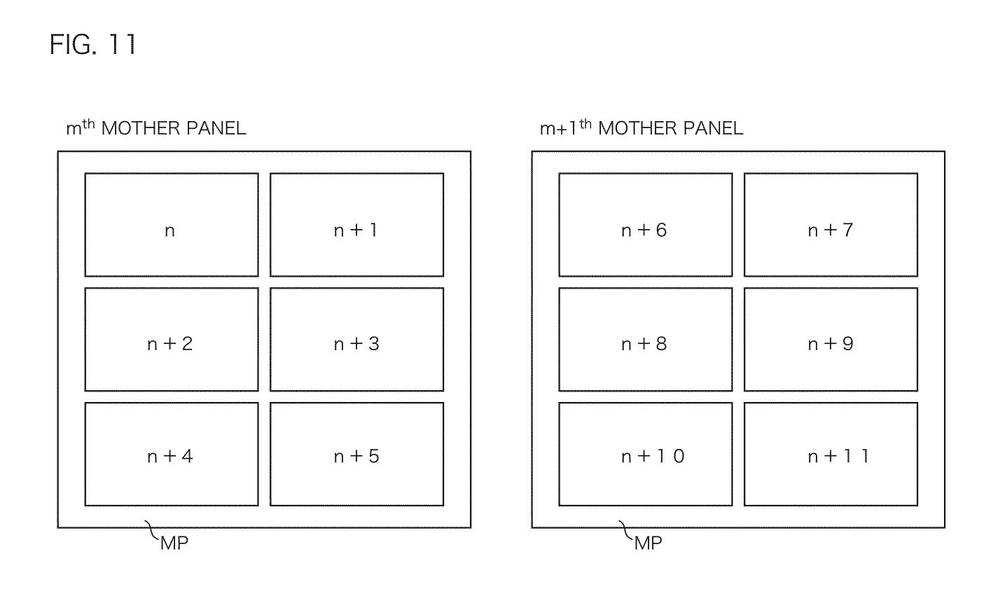

Accordingly, it is possible to specify the panel cut out from what order number of mother panels MP among the panels cut out on that day or the panel cut out from which position of the mother panel MP by referring to the identification information. FIG. 11 is a schematic view illustrating a method for specifying the panel. For example, in a case where the last five-digit number in identification information is n (n=6 m−5, m is a natural number), it is possible to determine that the panel is cut out from the position corresponding to “address 0” of the m^{th} mother panel MP. Similarly, in a case where the last five-digit number in the identification information is n+1 to n+5, it is possible to determine that panels are cut out from positions corresponding to “address 1” to “address 5” of the m^{th} mother panel MP.

Moreover, in a case where the last 5-digit number in identification information is n+6 (=6m+1), it can be determined that the panel is cut out from the position corresponding to “address 0” of the m+1^{th} mother panel MP. Similarly, in a case where the last five-digit numbers in identification information are n+7 to n+11, it can be determined that the panels are cut out from the positions corresponding to “address 1” to “address 5” of the m+1^{th} mother panel MP.

As described above, the production date of the liquid crystal display panel 10, the number of panels produced on the production date, and information of the position (address) of each of the panels cut out from the mother panel MP can be included in the identification information recorded in the liquid crystal display panel 10. Accordingly, by referring to the identification information, as for the respective panels cut out from the mother panel MP, it can be identified that the panel is cut out from which mother panel MP and from which position of the mother panel MP.

For example, the multi-display apparatus described in Embodiments 1 and 2 can be manufactured by selecting the plurality of the liquid crystal display panels 10, 10, . . . fabricated by panels cut out from the same mother panel MP by referring to the identification information. In addition, the multi-display apparatus described in Embodiment 3 can be manufactured by referring to the identification information and then specifying the address of the panel cut out from the same mother panel MP and selecting the liquid crystal display panels 10, 10 so that the arrangement of the liquid crystal display panels 10, 10 in the multi-display apparatus is the same as the arrangement of the panels in the original mother panel MP.

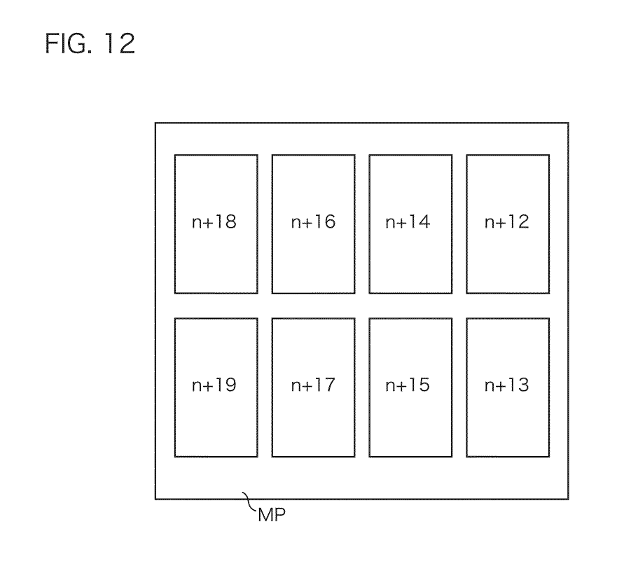

In a case where the size of the liquid crystal display panel 10 to be fabricated is varied, the assignment of the addresses may also be varied. FIG. 12 is a schematic view showing an example of assigning the addresses due to the size variation in the liquid crystal display panel 10.

Vertical and horizontal directions of each of the liquid crystal display panels 10 can be identified by the arrangement of the color filters 16, therefore, the identification information recorded in each of the liquid crystal display panels 10 is not required to hold information of vertical and horizontal directions of each of the liquid crystal display panels 10. The arrangement of the color filters 16 face the liquid crystal display panel 10 and is in the order of R, G, and B from the left side, therefore, the vertical and horizontal directions of the liquid crystal display panel 10 can be aligned by arranging each of the liquid crystal display panels 10 so as to correspond to the arrangement.

With regard to Embodiment 4, the identification information is configured to be recorded in the periphery of the TFT side glass substrate 11, however, the position for recording the identification information is not restricted to the periphery of the TFT side glass substrate 11. For example, as shown in FIG. 8, the black matrix 51 is arranged around each of the liquid crystal display panels 10, therefore, it may be configured to record the identification information with ink that reflects infrared light or ultraviolet light at the location of the black matrix 51 which can be visually recognized from outside. Ink containing, for example, particles of ITO (Indium Tin Oxide) or ATO (Antimony Tin Oxide) can be used as the ink for reflecting infrared light. In addition, ink containing luminescent compound of a europium complex can be used as the ink for reflecting ultraviolet light.

With regard to Embodiment 4, a sign composed of alphanumeric characters as the identification information of the liquid crystal display panel 10 is used. However, it is not necessarily to be the sign composed of alphanumeric characters. For example, it may be configured to record the identification information by using codes such as a barcode or a binary code.

In addition, with regard to Embodiment 4, a sign composed of a serial number indicative of the production date and the number of products in each day is used as the identification information. However, when the information can identify the origin of each of the liquid crystal display panels 10, any type of information may be used.

### Embodiment 5

With regard to Embodiment 4, it is configured to record identification information at an outer part of the liquid crystal display panel 10. However, it may be configured to cause storing means such as a memory to store identification information.

Each of the liquid crystal display panels 10 includes the LCD timing controller 105 and the source driver 106 as the configuration of the control system (see FIG. 2). Each of the LCD timing controller 105 and the source driver 106 has a built-in memory (not illustrated), and performs a variety of controls by referring to setting values stored in the flash memory.

The LCD timing controller 105 and the source driver 106 are provided for each of the liquid crystal display panels 10. Therefore, by using free capacity of a built-in flash memory in the LCD timing controller 105 or the source driver 106, the identification information as described in Embodiment 4 can be stored. In addition, the identification information stored in the flash memory can be read out by connecting a reading device such as a ROM writer to a connector.

In addition, by using a remote controller for remotely controlling each of the liquid crystal display panels 10 and executing the read-out of the identification information, the read identification information can be displayed in each of the liquid crystal display panels 10.

Moreover, it may be configured to read out the identification information by incorporating an IC chip (not illustrated) for recording the identification information into the source driver 106 and performing wireless communication with the IC chip.

In addition, it may be configured to manage the identification information of the liquid crystal display panel 10 to be used in a unit of the multi-display apparatus without directly recording identification information into the liquid crystal display panel 10. For example, it may also be configured to manage the identification information of each of the liquid crystal display panels 10, 10, . . . and information related to the arrangement of each of the liquid crystal display panels 10, 10, . . . in association with a lot number to be assigned to each multi-display apparatus. This lot number is normally given to each product (multi-display apparatus) from the perspective of traceability.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1-5. (canceled)

6. A multi-display apparatus comprising:
a plurality of liquid crystal display panels which are arranged to be tiled together contiguously for displaying an image respectively based on an input image signal; wherein
at least two of the plurality of liquid crystal display panels are cut out and fabricated from one mother panel having a gap formed for sealing a liquid crystal material.

7. The multi-display apparatus according to claim 6, wherein
two contiguous liquid crystal display panels among the plurality of liquid crystal display panels are configured as the liquid crystal display panels fabricated from said one mother panel.

8. The multi-display apparatus according to claim 6, wherein
at least two liquid crystal display panels are arranged to be tiled together contiguously so that arrangement relation of the liquid crystal display panels on said one mother panel is maintained.

9. The multi-display apparatus according to claim 7, wherein
at least two liquid crystal display panels are arranged to be tiled together contiguously so that arrangement relation of the liquid crystal display panels on said one mother panel is maintained.

10. The multi-display apparatus according to claim 6, wherein
information for specifying the mother panel from which the liquid crystal display panel is cut out is recorded in each of the liquid crystal display panels.
